(19) United States
(12) Patent Application Publication
(10) Pub. No.: US 2002/0011482 A1
(43) Pub. Date: Jan. 31, 2002

(54) Infrared heating device for prewarming water

(76) Inventor: Lawrence Gordon, Watauga, TX (US)

Correspondence Address: John W. Montgomery, Haynes and Boone, LLP, Suite 4300, 1000 Louisiana, Houston, TX, 77002, US

(21) Appl. No.: 09/908,221

(22) Filed: Jul. 17, 2001

Related U.S. Application Data
(63) Continuation-in-part of application No. 09/478,279, filed on Jan. 5, 2000, now Pat. No. 6,261,261.

(51) Int. Cl. H05B 3/02

(52) U.S. Cl. 219/480; 219/483

(57) ABSTRACT

An infrared device for prewarming water is provided with a cassette having a predetermined length of tubing connectable at an inlet to a watrer source and an inlet connected to a device for dispensing hot water. An infrared energy-generating sheet is positioned in the cassette on or adjacent to the tubing or passage. The infrared energy sheet includes a fiberglass support grid, a layer formed on support matrix from a mixture of carbon and polymeric materials capable of producing infrared radiation in response to electrical current passed there through. A pair of electrical conduction power strips are attached along opposite sides of the matrix layer and are attached to input power terminals to provide the required current. The entire cassette may be held together with a glue or may be otherwise bonded or molded into a unit for convenient handling. An electrical power source is connected to the input power terminals for providing electrical power to be passed through the power strips and the layer of carbon and polymer mixture to generate infrared radiation that passes through the tubing or passage and penetrates into the water as it passes through the cassette to be warmed thereby and infused into a patient at a desired temperature.

This invention is a continuation-in-part of the Provisional U.S. patent application Ser. No. 09/478,279 filed on Jan. 5, 2000, U.S. Pat. No. 6,261,261 issued Jul. 17, 2001 entitled “Infrared Heating Device for Prewarming IV Solutions”.

### BACKGROUND OF THE INVENTION

1. Technical Field of the Invention

The present invention relates to devices for preheating water prior to dispensing from a hot water tap or vlave, and more particularly to a disposable cassette having an infrared heating element electively powered for heating water in a pipe prior to dispensing so that hot water is dispensed immediately.

2. Background of the Invention

It has been found that the distance form a hot water heater to a dispensing tap, as at a sink, a shower or a bath, is normally sufficiently far so that it can take a significant amount of time after a hot water tap is opened and before the hot water is dispensed. Thus there is a need for an inexpensive and reliable infrared device for prewarming water in a pipe immediately prior to dispensing same.

### SUMMARY OF THE INVENTION

Applicant has provided an infrared device for prewarming water prior to dispensing that comprises a cassette having a predetermined length of tubing or a passage corresponding in size to the inside diameter of standard water pipe. The passage has an inlet connectable to a source of water and an outlet connectable to a dispensing tap, such as at a sink, a shower valve, or a bathtub. At least one infrared energy-generating sheet is positioned in the cassette adjacent to the predetermined length of tubing. The infrared energy-generating sheet includes a fiberglass support grid and a matrix layer of a mixture of carbon and polymeric materials formed on the support grid for producing infrared radiation in response to electrical current passed through the matrix layer. A pair of electrical conduction power strips are placed along opposite sides of the matrix layer. Input power terminals are connected to the electrical conduction power strips and an electrical power source is connected to the input power terminals for providing electrical power to be passed through the power strips and thereby pass through the matrix layer of carbon and polymer mixture to generate infrared radiation. The cassette holds the infrared energy-generating sheet adjacent along the predetermined length of tubing so that the infrared energy is transferred to water carried through the tubing.

Preferably, a temperature control microchip is provided operatively connected for sensing the temperature that results from infrared heating of the water and automatically controls the electrical power to the infrared energy-generating sheet to maintain a desired temperature. When hot water from a remote water heater reaches the infrared prewarming unit, the temperature sensor acts to discontiue the power to the infrared heating unit.

### BRIEF DESCRIPTION OF THE DRAWINGS

The foregoing objects, advantages, and features, as well as other objects and advantages, will become more apparent with reference to the description and drawings below, in which like numerals represent like elements and in which:

FIG. 1 schematically depicts an infrared heating layer according to one aspect of the present invention;

FIG. 2 schematically depicts a cassette having a predetermined length of tubing with the infrared heating element positioned therealong, and particularly the length of tubing is shown in a serpentine pattern formed on both sides of a small area of infrared energy-generating sheet, thereby facilitating heat transfer to the tubing;

FIG. 3 shows an alternative embodiment in which a predetermined length of tubing is positioned in a spiral pattern along one side of a heating element passing through a central orifice and spiraling outwardly to an outlet;

FIG. 4 shows a schematic depiction of an assembly view of an infrared heat-generating sheet according to the present invention;

FIG. 5 shows a cross-section view of an infrared heating sheet formed according to assembly view FIG. 4; and

FIG. 6 is a schematic perspective view of an alternative embodiment of a cassette with a serpentine passage therethrough sandwiched between two heat-generating sheets, each having inwardly reflective material laminated on the outside thereof.

### DETAILED DESCRIPTION OF THE PREFERRED EMBODIMENTS

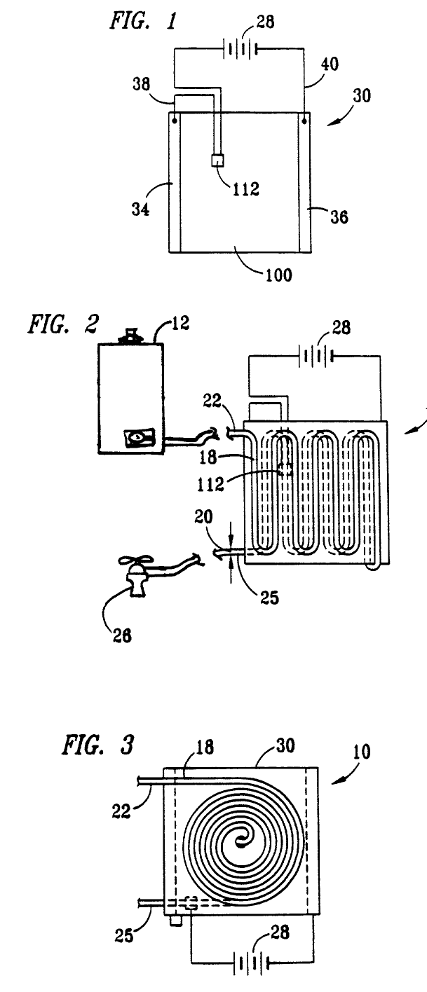

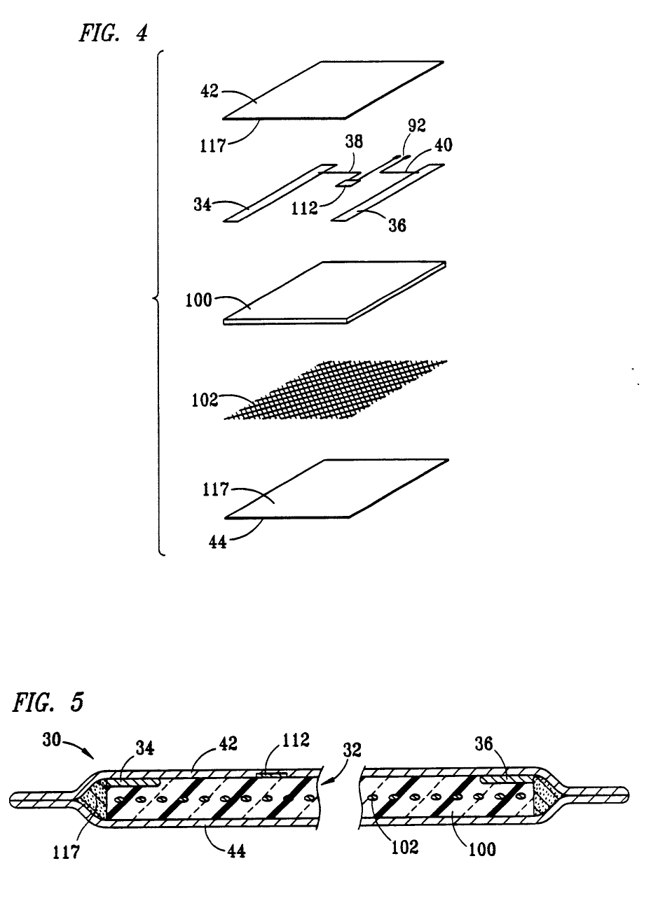

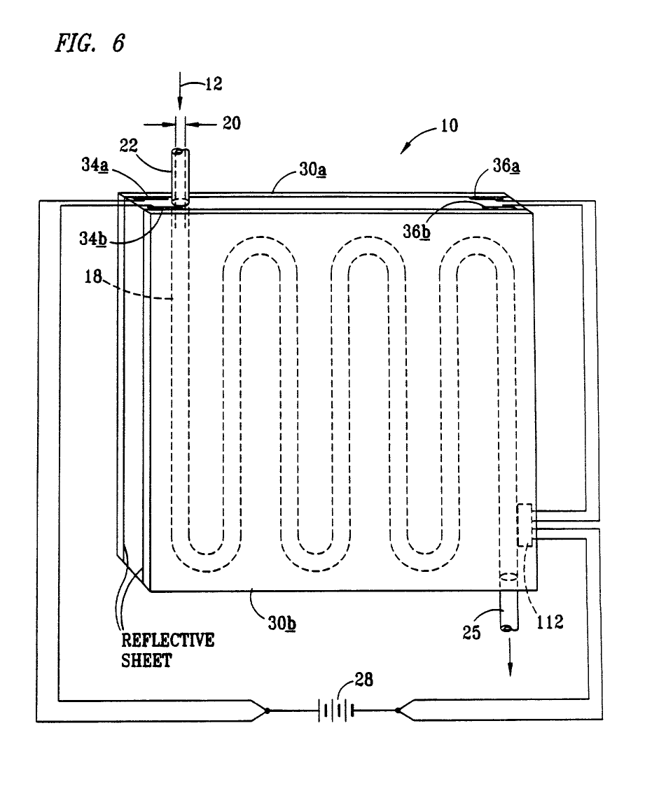

FIGS. 2 and 3 show an infrared device 10 for prewarming water 12 that comprises a cassette 14 having a predetermined length 16 of water pipe 18 or a passage 18 corresponding in size to the inside diameter 20 of standard water pipe. The passage 18 has an inlet 22 connectable to a source 12 of water, such as a domestic or industrial hot water heater, and an outlet connectable to a water dispensing device 26 such as a sink hot water tap, a shower hot water valve or a bath tub for prewarmed water for immediate dispensing. At least one infrared energy-generating sheet 30, as shown in FIGS. 1, 4 and 5, is positioned in the cassette adjacent to the predetermined length of water pipe 18. The infrared energy-generating sheet 30 includes a fiberglass support grid 102 and a matrix layer 100 of a mixture of carbon and polymeric materials formed on the support grid for producing infrared radiation in response to electrical current passed through the matrix layer. A pair of electrical conduction power strips 34 and 36 are placed along opposite sides of the matrix layer. Input power terminals 92 are connected to the electrical conduction power strips 34 and 36 and an electrical power source 28 is connected to the input power terminals for providing electrical power to be passed through the power strips and thereby pass through the matrix layer of carbon and polymer mixture to generate infrared radiation. A portable storage battery, preferably less than 24 volts, as for example, 12 volts can be used as the power source 28. The cassette holds the infrared energy-generating sheet adjacent along the predetermined length of water pipe so that the infrared energy is transferred to water carried through the tubing. Preferably, a temperature control microchip 112 is provided operatively connected for sensing the temperature that results from infrared heating of the water and automatically controls the electrical power to the infrared energy-generating sheet to maintain a desired rate of heating. The matrix layer 100 on support grid 102 may be laminated between high temperature polymeric sheets 42 and 44 bonded together with bonding agent 117.

Other alterations and modifications of the invention will likewise become apparent to those of ordinary skill in the art upon reading the present disclosure, and it is intended that the scope of the invention disclosed herein be limited only by the broadest interpretation of the appended claims to which the inventors are legally entitled.

What is claimed is:

1. An infrared device for prewarming water prior to dispensing comprising:
(a) at least one cassette having a predetermined length of tubing passing therethrough with an inlet connectable to a source of water and an outlet connectable to a water dispensing device;
(b) at least one infrared energy-generating sheet positioned in said cassette adjacent to said predetermined length of tubing, said infrared energy sheet further comprising:
i) a fiberglass support grid;
ii) a matrix layer formed on said support grid, said matrix layer comprising a mixture of carbon and polymeric materials capable of producing infrared radiation in response to electrical current passed therethrough;
iii) a pair of electrical conduction power strips along opposite sides of said layer;
iv) a polymeric laminate enclosing said support grid, said matrix layer and said electrical conduction power strips, said polymetric laminate being substantially transparent to infrared radiation;
v) input power terminals connected to said electrical conduction power strips; and
(c) an electrical power source connected to said input power terminals for providing electrical power to be passed through said power strips and said matrix layer of carbon polymer mixture to generate infrared radiation therefrom.

2. An infrared device for prewarming Water as in claim 1 further comprising:
(a) predetermined area in said cassette on which said predetermined length of tubing is held in a serpentine configuration; and
(b) said infrared energy-generating sheet operatively positioned adjacent said tubing co-terminus with said predetermined area.

3. An infrared device for prewarming water as in claim 1 further comprising a temperature control device operatively connected to said cassette for automatically terminating power to said power conducting strips when a temperature in said cassette exceeds a predetermined temperature.

4. An infrared device for prewarming water as in claim 3 wherein said temperature control device comprise a microchip circuit sensitive to a preselected temperature and connected to said input power for turning power “on” below said preselected temperature and “off” above said preselected temperature.

5. An infrared device for prewarming water as in claim 1 wherein said cassette further comprises:
(a) said at least one heating element forming a bottom of said cassette; and
(b) a top of said cassette spaced above said bottom and having another infrared radiation generating sheet positioned along said top for heating on said tubing from above.

6. An infrared heating device for prewarming water as in claim 1 further comprising:
(a) a thermostat connected in said cassette for sensing a temperature indicative of the temperature of said water to be warmed; and
(b) a control circuit connected to said thermostat and said infrared heating element for controlling power to said infrared heating element so that a predetermined temperature range is maintained in said compartment.

7. An infrared heating device for prewarming water as in claim 7 wherein said control circuit comprises a temperature responsive microchip circuit preset for turning on and off at a predetermined temperature.

8. A disposable infrared warming device for prewarming water comprising:
(a) at least one cassette having a length of water passage and an inlet for receiving water warmed and an outlet for connecting to a dispensing device to receive dispense said warmed water, said infrared heating device comprising:
(b) at least one infrared energy-generating sheet positioned in said compartment adjacent to said length of water passage, said infrared energy sheet further comprising:
(i) a fiberglass support matrix;
(ii) layer formed on said support matrix, said layer comprising a mixture of carbon and polymeric materials capable of producing infrared radiation in response to electrical current passed therethrough;
(iii) a pair of electrical conduction power strips along opposite sides of said layer;
(iv) polymeric laminate enclosing said support grid, said layer and said electrical conduction power strips, said polymeric laminate being substantially transparent to infrared radiation; and
(c) an electrical power source connected to said input power strips for providing electrical power to be passed through said power strips and said layer of carbon polymer mixture to generate infrared radiation therefrom.

9. A disposable infrared water prewarming device as in claim 9 further comprising:
(a) a power cord adapted to connect to a movable power source; and
(b) a portable battery power source movable from one patient to another as may be needed to connect to said disposable cassette infrared heating device.
